(19) United States
(12) Patent Application Publication
(10) Pub. No.: US 2006/0146469 A1
(43) Pub. Date: Jul. 6, 2006

(54) System and method for monitoring equipment

(76) Inventors: David Q. Heagerty, Glen Mills, PA (US); Gregory L. McGee, Cedar Park, TX (US)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(21) Appl. No.: 11/268,022

(22) Filed: Nov. 7, 2005

Related U.S. Application Data
(60) Provisional application No. 60/625,865, filed on Nov. 8, 2004.

(51) Int. Cl. H01H 73/00

(52) U.S. Cl. 361/115

(57) ABSTRACT

An intrinsically safe equipment condition monitoring system is provided. The system includes at least one intrinsically safe local data acquisition unit for acquiring condition information for at least one piece of equipment. The local data acquisition unit includes a data transmitter for wirelessly transmitting the acquired condition information. A remote data receiving unit is provided for receiving the condition information for the piece of equipment.

### RELATED APPLICATIONS

This application claims the benefit of U.S. Provisional Application No. 60/625,865, filed Nov. 8, 2004.

### FIELD OF THE INVENTION

The present invention relates generally to advanced monitoring of mechanical and electromechanical equipment, and, more particularly, to acquiring and wirelessly transmitting equipment condition data.

### BACKGROUND OF THE INVENTION

There are many types of plant-specific equipment in any industrial process and/or production facility. Such equipment can be motors, pumps, valves, compressors, engines, etc., either alone, or in combination, which function to process or manufacture, to control, or to monitor plant operations.

A system and method exist for monitoring the condition of isolation and shutdown valves in their normal (open) operational mode. Isolation and shutdown valves are valves that normally are installed in a section of pipe and are intended to be either manually or automatically closed for safety, shutdown, or maintenance reasons. To ensure their continued availability and reliability, certain codes and regulations require that these valves be periodically “stroked” or otherwise tested to ensure their readiness. Since stroking or testing of the valves requires that the valves be closed, normal facility operations must be partially or fully stopped during the testing, thereby affecting production.

One known system eliminates the need for closure of these valves employed on off-shore oil and gas platforms, as well as in other industrial and commercial applications such as commercial nuclear power, etc. The known system is fully described in U.S. Pat. Nos. 6,128,946 and 6,134,949, the contents of which are incorporated herein by this reference in their entireties. As described in these patents, one or more sensors and associated transmitters are interconnected to upstream and downstream piping, and to a monitored valve cavity therebetween. Cables from the sensors are routed to a location proximate the equipment location, generally referred to as a “junction box.” Because the electrical signals/impulses from each sensor must be transmitted to a centralized location, or remote “safe” room, for analysis or further transmission, the wiring for each sensor must be individually, physically routed to the remote room. In a commercial installation, the remote safe room may be hundreds of feet away from the monitored equipment, requiring the cables to be routed in protective armored conduits/sheathing.

Those skilled in the art will appreciate that where dozens or even hundreds of isolation valves must be monitored, the costs of installing protected conduit over many hundreds of feet are substantial. The space needed to route such large numbers of one inch or larger diameter conduit is significant, as are the structural support requirements in terms of cable trays and hangers.

Additionally, many industrial facilities, in whole or in part, comprise hazardous areas where combustible gases are present at least part of the time. Even the smallest spark from a piece of electrically-energized equipment or circuit, or a high surface temperature, can cause an ignition having disastrous consequences. In such environments, equipment and circuitry design must preclude sparking or elevated temperatures. This sort of design, referred to as “intrinsically safe,” requires various electrical isolation barriers, limiting devices, and power and temperature restrictions. Where extensive cabling to and from the remote room is required, the costs of designing and installing intrinsically safe systems becomes prohibitively expensive. Further, such installations create congestion in work areas, exacerbating personnel safety issues.

### SUMMARY OF THE INVENTION

The present invention is directed to a system and method that addresses at least the above-described problems. More specifically, the present invention is directed to a system for monitoring, acquiring, and wirelessly transmitting data regarding plant equipment, thus eliminating most of the cabling associated with the prior art system.

One aspect of the present invention is directed to an intrinsically safe, high speed synchronous multiple channel equipment condition monitoring system including at least one intrinsically safe local data acquisition unit and a remote data receiving unit. For the system to be intrinsically safe, the local data acquisition unit is constructed to the criteria of International Electrotechnial Commission (IEC) Standard 60079, Electrical Apparatus for Explosive Gas Atmospheres. The local data acquisition unit acquires condition information for at least one piece of equipment via a hardwired connection to one or more sensors mounted on or proximate the piece of equipment. The data acquisition unit further includes a data transmitter in the form of an RF digital communications module which transmits wirelessly to a remote data receiving unit. According to one exemplary embodiment, the local data acquisition unit is readily configurable within a protective enclosure for one or more types and numbers of application-specific condition monitoring modules. Once the operating condition information is acquired and processed, it is then either analyzed at an onsite remote data receiving unit or is subsequently transmitted to an offsite location via a TCP/IP network, or other suitable communications protocol, for analysis.

Another aspect of the present invention is directed to a method for monitoring equipment. The method includes a first step of acquiring information from at least one piece of equipment with an intrinsically safe data acquisition unit that is located proximate the monitored equipment. Typically, the condition information is acquired as an analog input. The analog input is then conditioned and converted by intrinsically safe components to a digital output that is wirelessly transmitted to an onsite remote data receiving unit. The input received by the remote data receiving unit is then either (1) analyzed locally, or (2) re-transmitted over a TCP/IP network or other suitable communications protocol to a remote data analysis unit.

### BRIEF DESCRIPTION OF THE DRAWINGS

FIG. 1 is a simplified schematic of a typical off-short platform illustrating isolation and shutdown valve configurations requiring testing.

FIG. 2 is a schematic illustrating a system for monitoring the condition of the valves shown in FIG. 1.

FIG. 3 is a schematic illustrating the system of the present invention.

FIG. 4 is a schematic of the local data acquisition unit (LDAU) of the present invention.

FIG. 5 is a simplified block diagram for the general module configuration of the present invention.

FIG. 6 is a block diagram of the sensor interface for a Dual AC Module.

FIG. 7 is a block diagram of the sensor interface for a Strain Module.

FIG. 8 is a simplified block diagram of the communications module of the present invention.

FIG. 9 is a schematic further illustrating the detailed components of the communications module.

### DETAILED DESCRIPTION OF THE PREFERRED EMBODIMENTS

Certain exemplary embodiments of the present invention are described below and illustrated in the attached Figures. The embodiments described are only for purposes of illustrating the present invention and should not be interpreted as limiting the scope of the invention. Other embodiments of the invention, and certain modifications and improvements of the described embodiments, will occur to those skilled in the art, and all such alternate embodiments, modifications and improvements are within the scope of the present invention.

As described herein:

“Intrinsic safety” refers to a level of safety in which energy levels are low enough that a flammable gas ignition or explosion cannot occur. Intrinsic safety is achieved by limiting energy levels through the use of barriers and intrinsically safe circuits.

“Intrinsically safe circuit” is a circuit in which any spark or other thermal effect produced during normal operation, or fault conditions, is not capable of causing ignition in a given gaseous atmosphere.

“Module” refers to a self-contained component that can provide a complete function to a system and can be interchanged with other modules that provide similar or related functions.

“Sensor” refers to a device that detects or measures something by converting non-electrical energy to electrical energy.

“Transducer” refers to a device that converts one form of energy to another.

“Zone Zero” refers to an environment where explosive gases are continuously present.

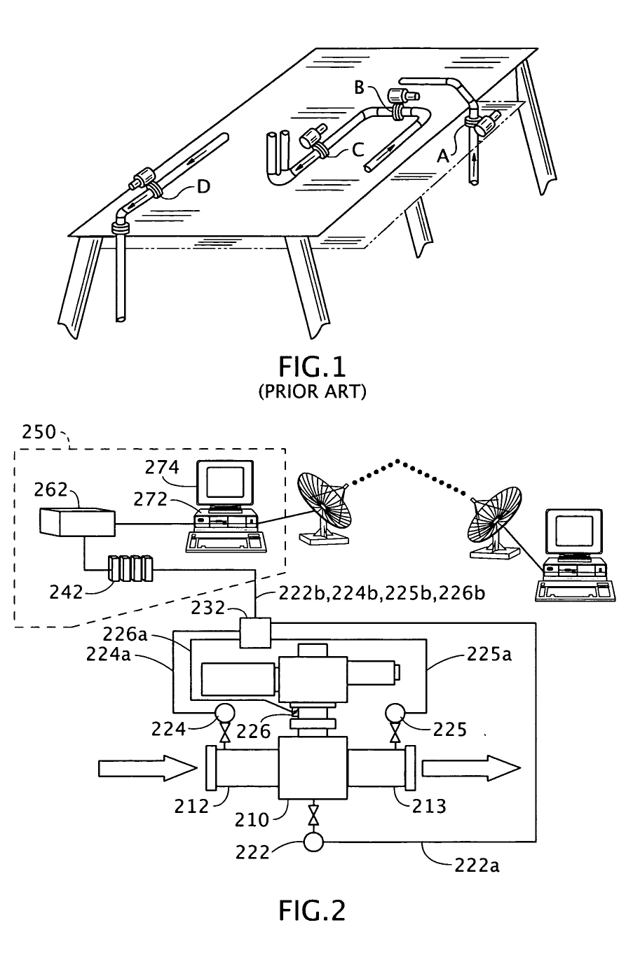

Monitoring the integrity of various types of plant equipment, including valves, is an operationally difficult and expensive undertaking. As shown in FIG. 1, isolation and shutdown valves must be periodically tested for compliance with various governmental environmental and transportation safety standards. On an offshore oil platform, for example, boarding valves (shown as Valve A), process valves (shown as B and C), and export valves (shown as Valve D) must all be tested on a required frequency to ensure their isolation and shutdown integrity.

In addition to the difficult and expensive undertaking of valve, or other equipment, testing, certain industrial environments are extraordinarily hazardous and require special design and operational considerations. In particular, where the environment is an offshore oil platform, explosive gaseous atmospheres are continuously persistent, caused by mixtures of air and gases, or vapors and mists, that exist under normal atmospheric conditions. Electrical circuits and energized equipment operating in these environments must be designed to one or more industry standards so that they are intrinsically safe. One such internationally-recognized standard is International Electrotechnical Commission (IEC) Standard No. 60079, Electrical Apparatus for Explosive Gas Atmospheres. IEC 60079, the content of which is incorporated herein in its entirety. Part 0 of IEC 60079 specifies the general criteria for electrical devices in explosive gaseous atmospheres, and Part 11 of the Standard further defines and specifies the criteria for Intrinsic Safety. In its simplest terms, intrinsic safety is concerned with two primary factors related to electric circuitry and electrical components: power level and surface temperature. As those skilled in the art will appreciate, in designing intrinsically safe electrical and electronic components, or circuits, designers must consider power, voltage, capacitance, resistance, inductance, and component operating temperatures; thus, there may be numerous “intrinsically safe” solutions for a particular application, each solution requiring a balance of electrical design parameters. The embodiments described herein are exemplary of the possible designs for the intrinsically safe components of the system of the present invention.

Because manual testing of valves by stroking (cycling) is labor intensive, potentially hazardous, and adversely affects production, the system described in detail in U.S. Pat. Nos. 6,134,949 and 6,128,946 was developed. FIG. 2 is in large part a simplified representation of these referenced patents. A typical shutdown or isolation valve 210 is typically situated between two generally straight sections of piping 212, 213. Such valves are typically power-actuated by an operator that is electrically or hydraulically operated. In the example shown in FIG. 2, sensors are conventionally installed in and interconnected to instrument taps, or bosses (not shown). More particularly, a dynamic pressure transducer 222 is located in the cavity of the ESD or other valve and at least one other dynamic pressure transducer 224 is located upstream or downstream 225 from the valve. A position sensor (not shown) is placed on the stem of the valve as well as a strain sensor 226 located on the yoke or the stem of the valve. The associated wiring, which is typically run in pairs 222a, 224a, 225a, 226a for each sensor, is routed from the valve to a local junction box 232. For example, a NEMA 4 enclosure may be used as the local junction box to provide some degree of weather resistance.

To satisfy IEC 60079, and other design codes, armored or clad-protected conduits 222b, 224b, 225b, 226b, corresponding to each of the sensors, are currently routed a considerable distance to a remote computer room. Electrical isolation barriers 242 must be installed in series in an on-site computer room 250 between the incoming conduits 222b, 224b, 225b, 226b and the data acquisition receiving unit (DAU) 262. This DAU 262 is installed in a conventional rack (not shown) with an associated server 272 and monitor 274, as best shown in FIG. 2.

As illustrated in the previously referenced patents, the leak analysis methodology uses transducers to sense sound in the valve cavity and upstream and downstream of the valve. The sound or “noise” detected by each transducer (sensor) provides an output that is correlated to coherence, transfer functions, and autospectra. Ultimately, the data is trended and gauged against a threshold for acceptable and non-acceptable leakage.

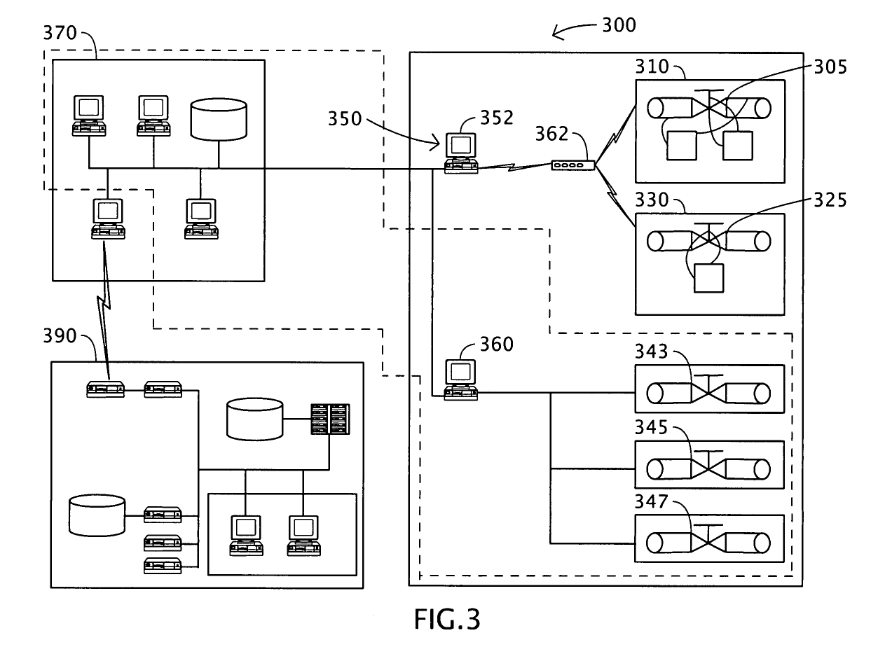

Referring to FIG. 3, one embodiment of the system of the present invention is illustrated for monitoring of the isolation and shutdown valves located within a flammable, combustive, or otherwise hazardous environment. The system, as described herein may also be used to monitor other types of valves and equipment; e.g., pneumatic control and process valves, motor-operated valve isolation and reliability, and check valve leakage and reliability. Further, the present system and method may be applied to many other types of plant equipment (pumps, motors, actuators, etc.) that are subject to performance and condition monitoring.

As shown in FIG. 3, one aspect of the present invention is directed to an intrinsically safe equipment condition monitoring system 300. In its simplest form, the system 300 comprises one or more intrinsically safe local data acquisition units (LDAU) 310, 330 for acquiring condition information for one or more pieces of equipment 305, 325. The LDAU 310, 330 is designed as a Deutsch Industrie Norm (DIN) rail-mounted device. As will be described in greater detail below, the LDAU 310, 330 is configured to transmit the equipment condition information wirelessly to a remote data receiving unit 350 which receives, and in one embodiment analyzes, the condition information for the equipment. The LDAUs 310, 330 and their wireless transmission capability may be used in combination with the condition monitoring system of the prior art. As shown, condition monitoring information for valves 343, 345, 347 may be hardwired to a remote data acquisition unit (RDAU) 360 onboard the platform. In the embodiment shown in FIG. 3, the equipment condition information may subsequently be transmitted offsite to the platform owner's analysis center 370 and/or an independent analysis center 390. Communications between the platform and offsite locations is accomplished over the Internet TCP/IP network or other suitable communications protocol.

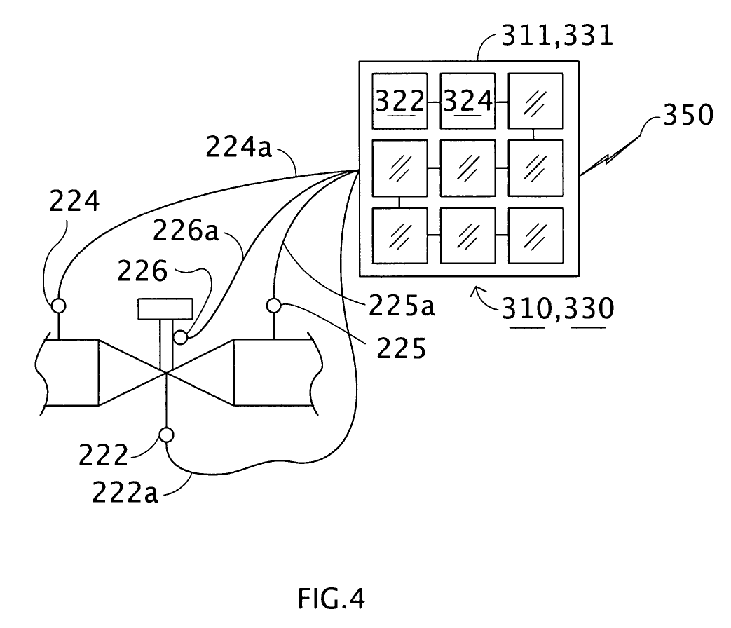

Turning now to FIG. 4, a representative LDAU 310,330 comprises an enclosure 311, 331 and a plurality of interchangeable modules, such as those shown generally as 322, 324. The enclosure 311, 331 serves as a junction box for hardwiring from the equipment sensors. The sensors are designed to be intrinsically safe in accordance with the design considerations of IEC Standard 60079, each requiring less than about 20 mW of power. While not shown in the Figure, the power supply for the LDAU may be provided locally proximate the LDAU for existing power supplies, with the use of a certified intrinsically safe battery. Alternatively, power may be provided via hardwiring from the safe room with the use of an intrinsically safe barrier. The hardwiring 222a, 224a, 225a, 226a is routed for interconnection with equipment-specific monitoring modules (for example, modules 322, 324). In this exemplary configuration, modules 322, 324 may be AC Dual pressure modules and/or Strain/AC modules, for example. Each module type comprises an RF/Digital communication component with a box-mounted antenna to transmit the digital signals acquired from the field-mounted sensors at a high speed of greater than 40 kbaud. Such high speed transmission supports a high sensor sampling rate. Each of these module types is described in greater detail below.

A key benefit of the LDAU is its installation in close proximity to one or more pieces of equipment being monitored. In exemplary embodiments, one LDAU is provided for one or more pieces of equipment being monitored. This minimizes the sensor lead (and armored conduits) length and installation in the Zone Zero (0) atmospherically gaseous environment. In one exemplary embodiment, the LDAU is mounted within a maximum of about 30 feet from the equipment being monitored. The enclosure is designed to meet ingress Protection Code IP56, in accordance with Standard BS EN 60592-1 (IEC 529-1), Degrees of Protection Provided by Enclosures and is dimensioned to enclose a plurality of modules of various types, but similar dimensions. The module types depend upon the types of equipment to be monitored and the equipment parameters being monitored. As such, one aspect of the present invention features a readily reconfigurable local (proximate the equipment location) data acquisition unit (LDAU) 310, 330 that provides signal conditioning and processing for data acquired from permanently installed transducers (typically force, pressure, vibration and position). Using a frame synchronous pulse and a common clock, high speed data is acquired synchronously across multiple sensors. Frame synchronization and clock tuning can occur over radio frequency. The modules then convert the specific data to a digital signal for transmission to a remote (on-station or on-platform) computer center for automatic and/or manual analysis. A periodic radio synchronization poll can be used as an acquisition synchronization pulse. All associated sensors in the network receive the synchronous pulse.

An isolated bus structure using optical or electromagnetic means are employed to provide isolation between modules. One typical enclosure 311, 331 for the LDAU 310, 330 of the present invention is thus approximately 12 inches high, 12 inches wide, and 8 inches deep. The dimensions of each module are limited to about 4 inches in height, 4 inches in width, and 1 inch in depth. When dimensioned in this manner, for example, the configuration of modules is easily changeable, flexible, and provides ease of wiring accessibility, labeling, and ease of installation and removal or replacement. Numerous configurations of the LDAU 310, 330 are possible with multiple modules arranged in series.

### General Module Design

Each module described herein is designed to operate in an environment comprising a temperature between about −40 degrees C. and 70 degrees C., a relative humidity between about 15% and 95% (non-condensing), ATEX Zone 0 for more than 1,000 hours per year in all gaseous areas, and with maximum surface temperatures not to exceed 135 degrees C. The intrinsically safe equipment monitoring system 300 is self-cooling, as no fans are incorporated into the system for this hazardous environment. Generally, each module of the present invention will operate on internal low voltage DC power, which is the only available power in an explosive environment. The voltage range in the Zone Zero environment ranges from between about 9 and 30 volts DC. This is sufficient to support the analog and digital circuitry for the module. The total power consumption for the LDAU should not exceed about 50 milliamps, and the total power consumption of the entire system should not exceed about 500 milliamps.

The actual number of modules is limited only by low voltage considerations for the platform environment for safe/fire concerns. In one exemplary embodiment, the LDAU comprises up to 14 modules, the number of modules being limited only by intrinsic safety and space considerations. For example, in such applications, the number and types of modules are limited by an upper limit on power, voltage, capacitance and inductance at the LDAU, not to exceed the requirements per IEC 60079.

As described in greater detail below, each module described herein comprises one or more channels with data storage capability, wherein data is stored until polled by the system software. Further, each module includes installed configuration information for the type of valve or other equipment information being gathered. This will include model number, serial number, calibration date, calibration sensitivity, calibration offset, sample rate, status registers, etc. An exemplary module has 12 pins and 12 plugs for interconnection in series with other modules. Resistor limiters are placed in series with each signal transmission line on all module inputs and outputs to assure proper isolation and energy limit requirements.

To support the functionality of the different module types, the LDAU bus is configured with two serial ports. Port 1 is a 2 pin bus that is used for determining the module information and configuration. Port 2 is a high speed synchronous serial bus for transmitting and receiving data in an efficient and expedient fashion. Further, the high speed bus includes a master clock pulse and synchronizing pulse. Port 2 also contains 1 or more lines for data transmittal across the individual modules. The actual number of data lines is limited by the number of pins available to the bus. Each pin has a current limiting resistor in series with the bus interconnect. This permits the modules to be configured in the field without any effects on the individual module entity parameters. The independent power connection for each module has diode isolation from the internal circuit capacitance to prevent excessive capacitance build up on the power bus while giving each module a low impedance path for input power to the module. Further, each module is specifically designed with low power, low voltage parts to ensure module stacking without compromising the intrinsically safe requirements for the environment in which it is installed. Furthermore, each module has double diode protection and resistor limiting for each of the sensor leads to the module. This ensures that excessive voltage and current do not escape the module, while providing a high impedance path for the signal values to pass into the module, and a low impedance path for the excitation circuits to pass out of the module.

### LDAU Module Configuration

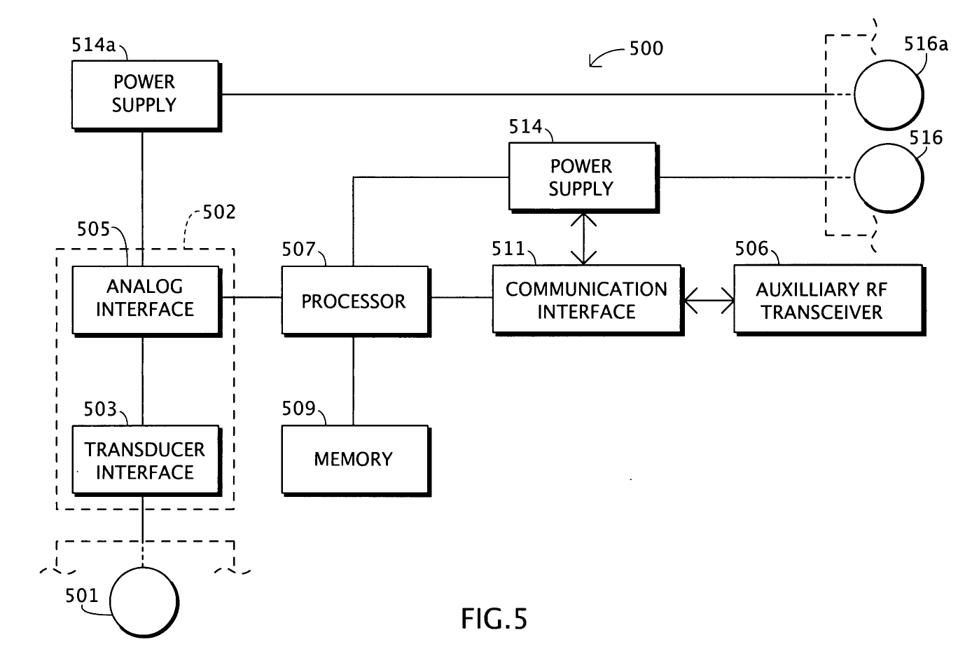

Having described the LDAU 310, 330 and the sensor-specific modules 322, 324 in general, the general configuration of an exemplary equipment monitoring module 322, 324 hardware and software configuration in accordance with the present invention is illustrated in FIG. 5. The general monitoring module 500, which is representative of the many possible equipment monitoring modules, e.g., 322, 324, comprises an arrangement for sensor-specific signals to be interfaced through a digital serial interface through a communications component. In general, each module 500 comprises a sensor-specific interface 502, which further comprises a transducer interface 503 and analog interface 505. These interfaces 503, 505 are further configured for the sensor inputs being monitored and received. The sensor-specific interface 502 for two representative, e.g., AC Dual Module (Pressure and Acoustics) and Strain/AC Module, sensor-specific modules are described in more detail below. Elements 501, 516, and 516A are the external interfaces of the module 500. Element 501 comprises the mechanical and electrical interface to the equipment-specific transducers for the equipment being monitored. Elements 516 and 516A are the power and data interfaces to the module 500. The power interface 516, 516A to the module 500 has been configured to transmit data over the power interconnection (commonly referred to as “data-over-power”) to reduce the total number of wires or cables required for the installed module.

Coupled to the sensor interface 501 is the transducer interface 503 of the sensor interface 502, which conditions, e.g., isolates, protects, amplifies, filters, buffers, etc., the sensor inputs and outputs. The transducer interface 503 interfaces with the analog interface block 505. The analog interface 505 functions in part as an analog to digital (A/D) converter or a digital to analog (D/A) converter to convert analog signals from the sensor to digital, digital signals to analog as required, and to manage any miscellaneous digital 10 (input/output) for the analog interface. The analog interface 505 also stores calibration and configuration information for the module 500. As shown in the Figure, the analog interface 505 is digitally interfaced to the module processor 507. This is the standard backbone to assure that different sensor types, as well as the number of sensors, can be configured in a selected module 500. The processor 507 and memory component 509 are coupled to provide the control, storage, and communications capability for the module 500. Power supplies 514 and 514A, which are internal to the module 500, function to convert unregulated DC input power to the regulated voltage levels for the components comprising the module 500. These power supplies further provide filtering and data coupling for the physical interface for the data-over-power aspect of the system. A communications interface 511 is configured in communication with the processor 507 and internal power supply 514 to serve as the physical interface for the radio frequency (RF) transceiver 506, as well as the protocol interface for RF or Data-over-Power (DOP) transmission of data signals. While not shown in FIG. 5, the transceiver 506 includes a box-mounted antenna for signal transmission. Thus, there are two methods for transferring data from the potentially explosive environment to a remote data acquisition unit 350 (see FIG. 3). The first is RF and the second is data-over-power.

### Signal Conditioning

Sensors and transducers generally generate signals that must be conditioned before a data acquisition system, such as the present system, can reliably and accurately acquire the signal. This front-end processing, referred to as signal conditioning, includes functions such as signal amplification, filtering, electrical isolation, and multiplexing. This is one of the functions of the sensor interface 502.

In the present invention, each module shall have a set scheme for identification which is stored locally within the module in Flash or EEPROM. One exemplary identification scheme for a module comprises a model and serial number. General signal conditioning considerations and design criteria are known in the art.

### AC (Alternating Current) Dual Module (Pressure and Acoustics)

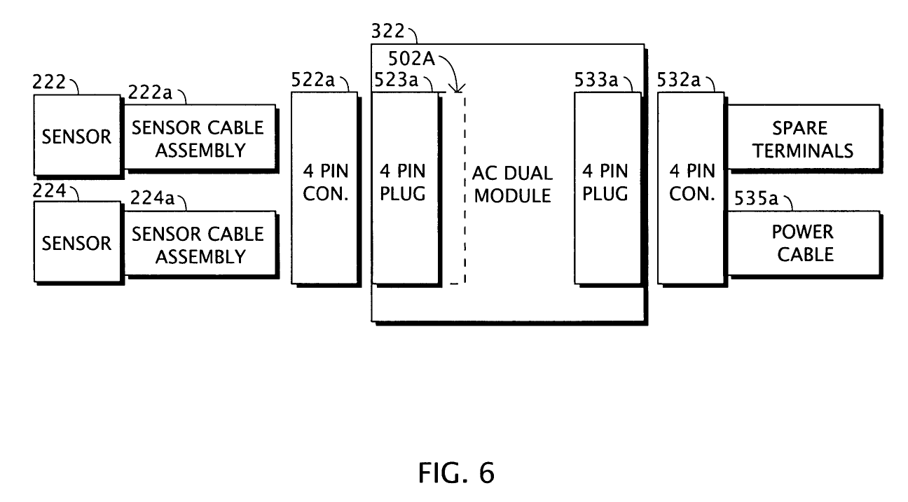

Depending upon the nature of the equipment parameters being monitored, signal conditioning is accomplished by the sensor interface 502 consistent with the input signal from the sensor. Referring again to FIG. 5, an exemplary transducer interface 503 and an exemplary analog interface 505 collectively form the sensor interface 502. While shown separately in the block diagram, these two interfaces 503, 505 function as a unit. One exemplary configuration for the Sensor and Analog Interface 502A, AC Dual Module, which is used to process pressure and acoustics signals, is illustrated in FIG. 6.

As shown in FIG. 6, the AC Dual Module (for example, module 322 of FIG. 4) is configured for two (dual) channels/sensors, 222, 224, for example (see also FIG. 4). The exemplary AC Dual Module 322 is comprised of the exemplary general features of the general module 500 discussed above with respect to FIG. 5 and has, for example, the additional specific features discussed regarding FIG. 6. For this interface 502A, one channel 222 provides an acoustic signal input while the second channel 224 provides a pressure signal input.

The sensor interface 502A performs excitation (power to the sensor), amplification (multiplication of the signal), level shifting (changing the reference point of a measurement), filtering, and analog to digital conversion.

Sensor cables 222a and 224a provide the hardwiring from the equipment to the LDAU, and hence the interface 502A to the module. Both the sensors 222, 224 and the sensor cables 222a, 224a are already known in the art and are described in the previously referenced patents. Two-pin input channels for each channel interconnect with a four-pin power terminal 522A which plugs into a four-pin plug 523A on the module casing. The terminal excitation/input for this interface 502A has a fixed 1 milliamp source current and a voltage range of about 8.3 volts. Optionally, power management capability is incorporated into the interface 502A and include A/D on/off and module on/off. The excitation and ground pins for the specific module 322 are resistor limited to effectively isolate energy in the module from passing externally to exposed hazardous areas. The excitation source will be generated from the internal 3.3 volt DC power. A DC to DC converter circuit (not shown) generates the necessary high excitation voltage levels. This converter circuit is designed for high frequency switching to reduce the inductive and capacitive circuitry associated with step up and filtering.

The signal from the sensor 222, 224 is an AC component of the excitation signal. The signal is resistor divided off of the excitation current lead. The resistor divider (not shown) is configured for fault tolerance to assure that a 9 volt excitation voltage cannot exceed the 3.3 volt power of the analog circuitry. The ground portion of the resistor divider is triplicated for intrinsic safety circuit considerations.

Output from the interface 502 to the processor 507 and power supply 514A (shown in FIG. 5) is also via 4-pin connectors 533A and 532A. A power cable 535A is provided for interconnection to the internal power supply 514A, shown in FIG. 5.

### Strain/AC Module

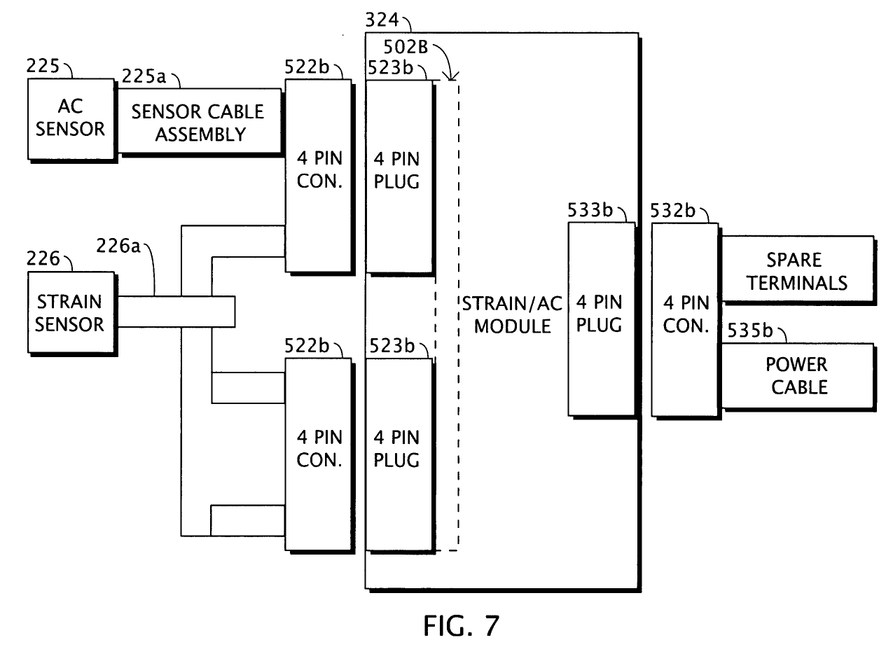

One exemplary configuration for the Sensor and Analog Interface 502B Strain/AC Module design is illustrated in FIG. 7. The AC pressure sensor input 225 is similar to that previously described for the Dual AC Module interface 502A. Additionally, interface 502B comprises an interface for a strain sensor input 226. An exemplary strain sensor is a balanced resistive Wheatstone bridge device that is used in a variety of sensors to measure various parameters. One example as it pertains to valve stem measurements is to measure the strain on a valve stem resulting from opening or closing of the valve gate, ball, or disc.

The sensor interface 502B also performs excitation (power to the sensor), amplification (multiplication of the signal), level shifting (changing the reference point of a measurement), filtering, and analog to digital conversion.

The Strain/AC module 324 is also configured for two (dual) channels/sensors, 225, 226, for example. For this interface 502B, one channel 226 provides a strain signal (resistance) input while the second channel 225 provides a pressure signal input. Sensor cables 226a and 225a provide the hardwiring from the equipment to the LDAU, and hence the interface 502B to the module. The input channels interconnect with four-pin power terminals 522b which plug into a four-pin plugs 523b on the module casing. Output from the interface 502 to the processor 507 (shown in FIG. 5) is also via 4-pin connectors 533b and 532b. A power cable 535b is provided for interconnection to the internal power supply 514A, shown in FIG. 5.

Power supply 514A for the interface 502B circuitry is similar to that described above for the AC Dual interface 502A. The strain channel 226 has six input pins dedicated to the strain sensor: (1) excitation +, (2) sense +, (3) excitation −, (4) sense −, (5) signal −, and (6) signal +. The strain channel has a fixed excitation voltage of approximately 3.0 volts. Due to intrinsic safety considerations and the various impedence changes of a strain sensor, the excitation values will vary based on the ratio of the strain sensor impedence to the value of Ri (input resistance). The excitation circuitry provides a maximum of 15 mA and has resistor current limiters on both positive and negative connections. The circuit is capable of driving a 350 ohm to 15 kohm bridge. Further included are resistor limiting (Ri) and zener (Z) diode protection. The excitation sense circuitry reads the actual excitation voltage applied at the end of the strain cable with an input range of 0 to 3 volts DC.

### RF/Digital Communications Component

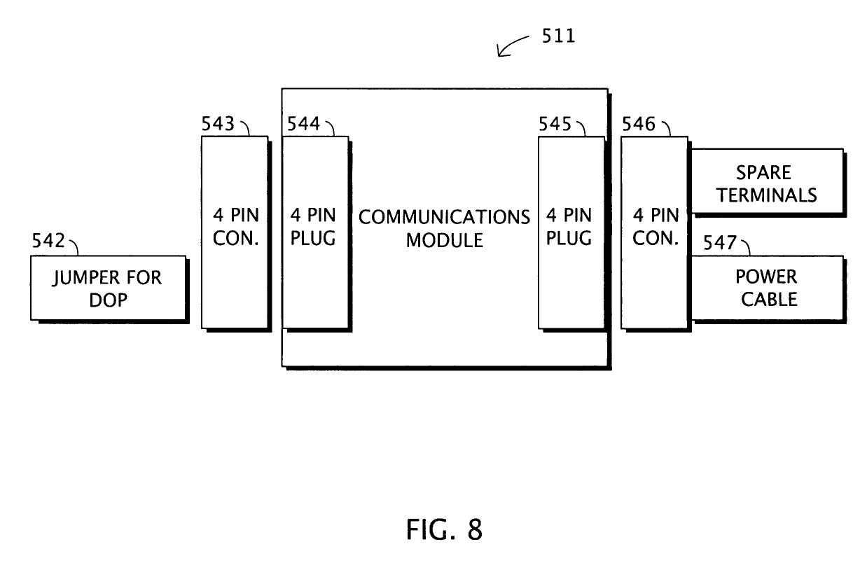

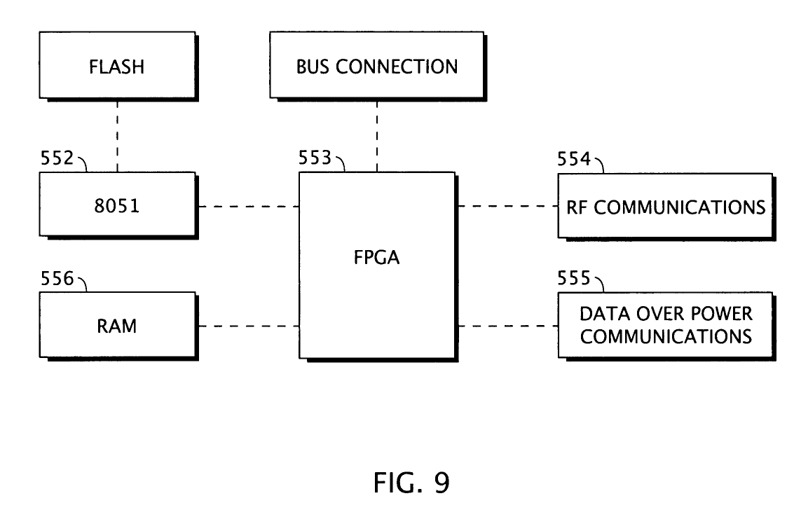

The system of the present invention further comprises a communications component, shown generally as 511 in FIG. 8. The communications component 511 is the controller of the sensor-specific module 322, 324 and is designed for initializing all hardware, saving configuration and identification information, and communicating between the sensor interfaces 502A, 502B and the remote data acquisition unit 350 (see FIG. 3). One exemplary embodiment of the communications component 511 is illustrated in FIG. 8. The communications component 511 comprises a connector/jumper 542 for adding or removing a jumper to define the mode of data transmission and for coupling to the module processor 507 via 4-pin connectors 543, 544. A 4-pin terminal connector 547 is provided for inputting power to the module via a 4-pin receptacle 546. Power supply from the power source 514 through cable 547 is provided to the communications component 511 via a 4-pin connector 546 which plugs into a 4-pin receptacle 545.

Referring now to FIG. 9, the communications component 511 of the exemplary embodiment further comprises a microprocessor 552 for performing general processing and housekeeping capabilities. A Field Programmable Gate Array (FPGA) 553 provides for real-time application requirements. Functions handled by the FPGA 553 include the Smart TDM (time division multiplexing) interface, the RF data-over-power link, memory interface, and other processing requirements that are not advantageously run on the processor 552. RF communications 554 and data over power communications interfaces 555 are configured within the module to provide unique communications benefits. Specifically, the configuration: (1) provides the ability to simultaneously transmit and receive data at radio frequency or over power interconnections, (2) provides a backup for wireless transmission when RF interferences are present in the platform/plant environment, (3) serves as a backup when stringent controls on the wireless frequency spectrum are necessary, and (4) permits a multi-link wireless to hardwired bridge configuration. A memory interface 556 is further provided as an address and data bus that is designed to meet the specifications of the microprocessor 552 to the system memory.

The exemplary communications module is configured for an operating frequency in the 2.4 Ghz range for United States, European, and Asian designs. Hardware interfaces for the modules meet IEC Standard 61158 for Zone Zero environments, with a total sustained payload transfer rate of about 31 kbps. For intrinsic safety purposes, the module utilizes resistors for isolating inductance from internal circuitry and comprises zener diode protection across the data-over-power connection.

### Data Receipt and Analysis

Turning again to FIG. 3, the wireless signal is transmitted from the LDAU 310, 330 RF communications component 511 (FIG. 5) to the platform computer room RF data acquisition receiver 350. In one embodiment, the communications component 511 has a transmission range of about 100 meters which enables the signal to be transmitted through the heavy industrial environment of the platform. The digital signals are then transmitted over a star configured wireless network, which may also comprise a repeater 362, depending upon the distance that the signal must be transmitted. The signal is received at the remote data acquisition unit 350. One or more data acquisition hubs (not shown) are mounted in one or more racks in the platform computer room. For electrical isolation and grounding purposes, at least one safety barrier module is typically mounted in series with a power supply which provides power to the wireless remote data acquisition unit 350. Similar to the LDAU configuration, a communications component (not shown) proximate the platform computer room is provided for receiving the wireless signal from the local data acquisition unit (LDAU) 310, 330. Finally, an Ethernet module is provided for interconnecting the unit 350 with a local server and/or conventional personal computer 352, which are co-located with the remote data acquisition unit 350.

Local data collection software in the platform computer room is installed on servers and/or personal computers whereby the signals are analyzed. In one embodiment, the signals are analyzed against specific criteria and/or threshold values to determine whether, for example, valve seals are leaking. As will be appreciated, a wide spectrum of software and algorithms may be developed for the specific type of equipment being monitored. The data may subsequently or simultaneously be transmitted via hardwire, or wireless transmission, to the operator's off-site location 370 (for example, an on-shore location), where it is stored in a database or analyzed further.

In an alternative embodiment, the operator's offsite communications software service may be accessible via the Internet TCP/IP, FTP protocol to an offsite data collection service 390. For example, the remote monitoring system vendor may provide a monitoring center to receive data, alarms, alerts, etc. regarding equipment integrity. When a problem with a piece of equipment is detected, the monitoring center 390 may then alert the operator of the problem so that prompt remedial action may be taken.

Although the present invention has been described with exemplary embodiments, it is to be understood that modifications and variations may be utilized without departing from the spirit and scope of the invention, as those skilled in the art will readily understand. Such modifications and variations are considered to be within the purview and scope of the invention.

We claim:

1. An intrinsically safe equipment condition monitoring system, comprising:
(a) at least one intrinsically safe local data acquisition unit for acquiring condition information for at least one piece of equipment, the at least one data acquisition unit including a wireless data transmitter; and
(b) a remote data receiving unit for receiving the condition information for the at least one piece of equipment from the wireless data transmitter.

2. The system of claim 1 wherein the local data acquisition unit is constructed to the criteria of International Electrotechnial Commission (IEC) Standard 60079, Electrical Apparatus for Explosive Gas Atmospheres.

3. The system of claim 1 wherein the at least one local data acquisition unit comprises:
(a) an enclosure; and
(b) at least one sensor module installed within said enclosure, the at least one sensor module corresponding to the at least one piece of monitored equipment.

4. The system of claim 3 wherein the local data acquisition unit is configured for a plurality of removably interchangeable sensor modules, each sensor module comprising at least one data channel.

5. The system of claim 3 wherein the at least one sensor module is selected from the group of modules consisting of pressure sensing, acoustics sensing, strain sensing, and combinations thereof.

6. The system of claim 3 wherein the at least one sensor module comprises a sensor interface, the sensor interface including:
(a) a sensor transducer interface; and
(b) an analog signal interface.

7. The system of claim 3 wherein the local data acquisition unit further comprises an internal power supply.

8. The system of claim 3 wherein the local data acquisition unit further comprises an internal processor programmed to control the acquisition, storage, and communications of data received by the local data acquisition unit.

9. The system of claim 1 wherein the data transmitter comprises an RF/digital communications module for transmitting the condition information to the remote data receiving unit.

10. The system of claim 9 wherein the RF/digital communications module is configured for simultaneous wireless and data-over-power connection transmission.

11. The system of claim 9 wherein the communications module is configured to transmit greater than 40 kbaud of digital data with a transmission range of at least about 100 meters.

12. The system of claim 9 further comprising a wireless remote data receiving unit.

13. The system of claim 12 wherein the wireless remote data receiving unit comprises:
(a) an electrical isolation device;
(b) a communications module for receiving a wireless signal from the data transmitter; and
(c) an Ethernet module that is selectively interconnectable to a local server.

14. The system of claim 12 further comprising a remote data analysis unit configured to analyze data received from the remote data receiving unit over a TCP/IP network.

15. A method for monitoring the condition of equipment, comprising:
(a) acquiring condition information for at least one piece of equipment with a data acquisition unit proximate the equipment, the condition information acquired as an analog input;
(b) converting the analog input to a digital output; and
(c) wirelessly transmitting the condition information digital output to a remote data receiving unit.

16. The method of claim 15 wherein the analog input is converted by an intrinsically safe circuit.

17. The method of claim 15 further including the steps of:
(a) receiving the digital output at the remote data receiving unit; and
(b) analyzing the condition information in a location proximate the remote data receiving unit.

18. The method of claim 15 further including the steps of:
(a) receiving the digital output at the remote data receiving unit; and
(b) transmitting the digital output over a TCP/IP network to a remote data analysis unit.
